(19) United States
(12) Patent Application Publication
(10) Pub. No.: US 2025/0189464 A1
(43) Pub. Date: Jun. 12, 2025

(54) CELL ASSEMBLY FOR ELECTRODE STRUCTURAL OBSERVATION

(71) Applicant: HONDA MOTOR CO., LTD., Tokyo (JP)

(72) Inventor: Atsushi SAKURAI, Saitama (JP)

(21) Appl. No.: 18/966,142

(22) Filed: Dec. 3, 2024

(30) Foreign Application Priority Data
Dec. 7, 2023 (JP) 2023-207018

(51) Int. Cl. G01N 23/046; H01M 10/42

(52) U.S. Cl. CPC G01N 23/046; H01M 10/4285

(57) ABSTRACT

A cell assembly includes a restraining member that restrains the cell, which is an observation target, from both surfaces of the cell in a thickness direction. The restraining member includes: a plate-shaped resin member that is arranged to cover a region a of an electrode opposing part related to the observation of the cell on one of the surfaces; and two metal leaf springs and that extend to face each other in a direction parallel to a main surface of the plate-shaped resin member toward a center part of the plate-shaped resin member with a predetermined gap g left between extended ends of the metal leaf springs, and press and bias a surface of the plate-shaped resin member on a side not in contact with the cell. The gap g is located at a position of irradiation with X-rays by the X-ray CT system.

This application is based on and claims the benefit of priority from Japanese Patent Application No. 2023-207018, filed on 7 Dec. 2023, the content of which is incorporated herein by reference.

### BACKGROUND OF THE INVENTION

### Field of the Invention

The present invention relates to a cell assembly for electrode structural observation.

### Related Art

A cell which is a constituent element of a secondary battery module undergoes expansion and contraction during charging and discharging. For this reason, the electrodes are often restrained in a thickness direction in use. Techniques for observing the structure of the electrodes in a state simulating the state of use have been proposed. For example, by one of the techniques, a cross section of the electrodes is observed using a scanning electron microscope (SEM) or a confocal optical system with the electrodes restrained in the thickness direction by a restraining member. If the expansion/contraction amount of the electrodes is large, it is difficult for these techniques to completely control the expansion of the electrodes in a direction projecting from the cross section machined for the observation. For this reason, there is concern that the observation results may differ from the behavior of the structure in actual use. The above concern is resolved if the observation is conducted by X-ray CT which does not require machining of a cross section for observation. However, the quality of X-ray CT images decreases due to X-ray absorption by the restraining member restraining the electrodes in the thickness direction. The decrease in image quality becomes an obstacle to making detailed observation.

As a cell assembly for electrode structural observation that allows the X-ray CT observation of a cell of a secondary battery restrained by a restraining member in the thickness direction, an assembly using a disk-shaped restraining member having a hole in the center that allows X-rays to pass through has been proposed (see, e.g., Patent Document 1).

Patent Document 1: Japanese Unexamined Patent Application, Publication No. 2012-159311

### SUMMARY OF THE INVENTION

According to the cell assembly for electrode structural observation of Patent Document 1, the hole that allows the X-rays to pass through is formed in the center of the disk-shaped member serving as the restraining member. In a disclosed example, the disc-shaped member has a tapered surface flared outward from its inner peripheral edge. This configuration is considered to allow the X-rays to be incident on the cell which is an observation target from a wide angle range. However, when the cell relatively rotates and the angle of incidence of the X-rays approaches 90 degrees, the X-rays incident on the cell are inevitably inhibited by the edge of the hole through which the X-rays pass. In recent years, increasing efforts have been made to achieve a low-carbon or decarbonized society, and research and development of devices for developing or testing electronic elements for vehicles are taking place in view of reduction of CO₂ emission and improvement in energy efficiency.

In view of the above circumstances, the present invention has been made to provide a cell assembly for electrode structural observation that does not block the X-rays incident on the cell which is the observation target, although the target cell relatively rotates about a rotation axis orthogonal to an optical axis of the X-rays and the angle of incidence of the X-rays approaches 90 degrees. Further, the present invention improves the efficiency of X-ray irradiation of the cell, contributing to improvement in energy efficiency.

A first aspect of the present invention is directed to a cell assembly for structural observation (e.g., a cell assembly 1 for structural observation described later) for observing an internal structure of a cell (e.g., a cell 3 described later) with an X-ray CT system. The cell assembly includes a restraining member (e.g., a restraining member 4 described later) that restrains the cell, which is an observation target, from both surfaces of the cell in a thickness direction. The restraining member includes: a plate-shaped resin member (e.g., a plate-shaped resin member 10 described later) that is arranged to cover a region (e.g., a region described later) of an electrode opposing part (e.g., an electrode opposing part 9 described later) related to the observation of the cell on one of the surfaces; and two metal leaf springs (e.g., two metal leaf springs 11 and 12 described later) that extend to face each other in a direction parallel to a main surface of the plate-shaped resin member toward a center part of the plate-shaped resin member with a predetermined gap (e.g., a gap g described later) left between extended ends of the metal leaf springs, and press and bias a surface of the plate-shaped resin member on a side not in contact with the cell. The gap is located at a position of irradiation with X-rays by the X-ray CT system.

According to a second aspect of the present invention, in the cell assembly for structural observation of the first aspect, the restraining member is supported by a rotation support member (e.g., a rotation support member 2 described later) that rotates the cell about a predetermined rotation axis (e.g., a virtual rotation axis Va described later) during the observation by the X-ray CT system, and the gap extending in a direction of the rotation axis between the two metal leaf springs is located in the region of the electrode opposing part.

According to a third aspect of the present invention, in the cell assembly for structural observation of the first aspect, each of the two metal leaf springs has a base part (e.g., a base part 13 or 14 described later) that is opposite to the extended end and supported by a support member (e.g., a support member 15 described later), and the extended ends are located in the region of the electrode opposing part.

According to a fourth aspect of the present invention, in the cell assembly for structural observation of the first aspect, the region of the electrode opposing part is located between a positive electrode terminal (e.g., a positive electrode terminal 20 described later) extending from the cell and a negative electrode terminal (e.g., a negative electrode terminal 19 described later) extending from the cell.

According to a fifth aspect of the present invention, in the cell assembly for structural observation of the first aspect, the region of the electrode opposing part is located between a positive electrode busbar (e.g., a positive electrode busbar 22 described later) connected to a positive electrode terminal extending from the cell and a negative electrode busbar (e.g., a negative electrode busbar 21 described later) connected to a negative electrode terminal extending from the cell.

According to a sixth aspect of the present invention, in the cell assembly for structural observation of the fifth aspect, a container (e.g., a container 23 described later) is provided to contain the positive electrode terminal, the negative electrode terminal, the positive electrode busbar, and the negative electrode busbar, and the container has a positive electrode opening (e.g., a positive electrode opening 27) and a negative electrode opening (e.g., a negative electrode opening 26) formed to allow the positive electrode busbar and the negative electrode busbar to be energized from outside during the observation by the X-ray CT system.

The cell assembly for structural observation of the first aspect allows the X-ray CT system to irradiate the target cell with the X-rays through the gap between the extended ends of the two metal leaf springs. Thus, the incoming X-rays are not blocked although the angle of the X-rays incident on the cell approaches 90 degrees, improving the efficiency of the X-ray irradiation of the cell.

The cell assembly for structural observation of the second aspect can keep the metal leaf springs from absorbing the X-rays when the X-ray CT system irradiates the target cell rotating about the predetermined rotation axis with the X-rays.

The cell assembly for structural observation of the third aspect can keep the support members each supporting the metal leaf spring at the base part from absorbing the X-rays when the X-ray CT system irradiates the target cell rotating about the predetermined rotation axis with the X-rays.

The cell assembly for structural observation of the fourth aspect can keep the positive electrode terminal and the negative electrode terminal both extending from the cell from absorbing the X-rays when the X-ray CT system irradiates the target cell rotating about the predetermined rotation axis with the X-rays.

The cell assembly for structural observation of the fifth aspect can keep the positive electrode busbar and the negative electrode busbar both extending from the cell from absorbing the X-rays when the X-ray CT system irradiates the target cell rotating about the predetermined rotation axis with the X-rays.

The cell assembly for structural observation of the sixth aspect allows the positive electrode busbar and the negative electrode busbar both extending from the cell to be energized from outside during the observation by the X-ray CT system, allowing the observation of the cell under the same conditions as the charging. Specifically, the observation can be conducted by changing the state of charge (SOC) of the cell 3.

### BRIEF DESCRIPTION OF THE DRAWINGS

FIG. 1 is a perspective view showing a cell assembly for structural observation of the present disclosure; and FIG. 2 is a cross-sectional view of the cell assembly for structural observation taken along line A-A shown in FIG. 1.

### DETAILED DESCRIPTION OF THE INVENTION

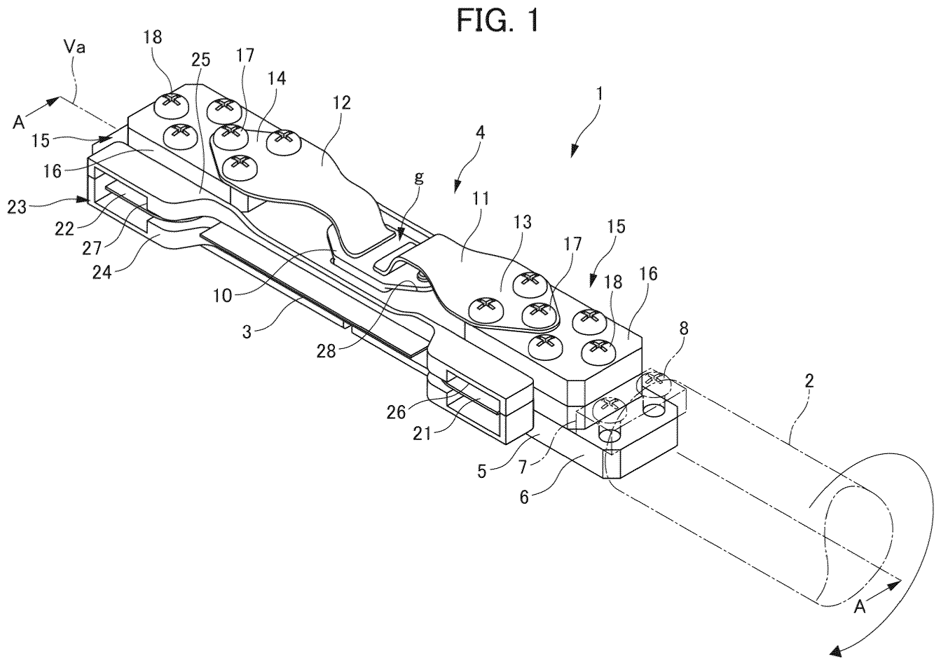

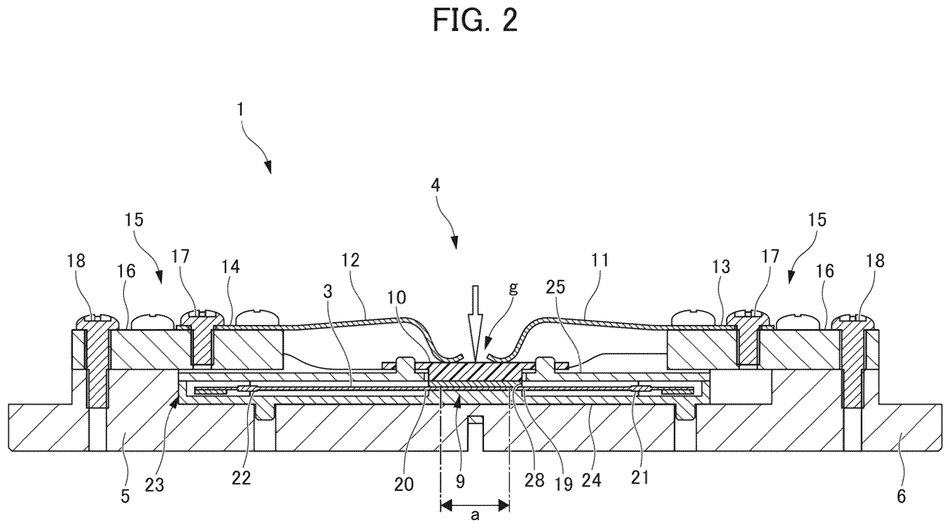

FIG. 1 is a perspective view showing a cell assembly 1 for structural observation of the present disclosure. FIG. 2 is a cross-sectional view of the cell assembly 1 for structural observation taken along line A-A. FIG. 1 shows the cell assembly 1 for structural observation attached to a rotation support member 2 described later, and a rotation axis (virtual rotation axis Va) of the cell assembly 1 for structural observation and the rotation support member 2 is shown to be inclined with respect to a vertical direction. However, the direction of the rotation axis Va is suitably determined depending on the form or working situation of an X-ray CT system (not shown).

The cell assembly 1 for structural observation is an assembly for observing the internal structure of a cell which is a constituent element of a secondary battery module with the X-ray CT system (not shown). The cell assembly 1 for structural observation includes a restraining member 4 that sandwiches and restrains a flat cell 3, which is an observation target, from both surfaces of the cell 3 in a thickness direction. The restraining member 4 has a base member 5 which is a plate-shaped member having a longitudinal direction parallel to the rotation axis Va. The base member 5 is fastened, at a base portion 6 on one end in the longitudinal direction, to a mount 7 which is rectangular parallelepiped-shaped, for example, and protrudes from an end surface of the rotation support member 2 with screws 8. The rotation support member 2 is rotated by a rotary drive mechanism (not shown), turning the cell assembly 1 for structural observation.

The restraining member 4 includes a plate-shaped resin member 10 and two metal leaf springs 11 and 12 on one of main surfaces of the base member 5. The plate-shaped resin member 10 is arranged to cover a region a of an electrode opposing part 9 related to the observation of the cell 3 on one of the cell surfaces. The metal leaf springs 11 and 12 press and bias a surface of the plate-shaped resin member 10 on a side not in contact with the cell 3. The two metal leaf springs 11 and 12 extend to face each other in a direction parallel to the main surface of the plate-shaped resin member 10 toward a center part of the plate-shaped resin member 10 with a predetermined gap g left between their extended ends. The gap g is located at a position of irradiation with X-rays by the X-ray CT system (a position indicated by an open downward arrow in FIG. 2). Specifically, the gap g is formed in the region a of the electrode opposing part 9. In other words, the extended ends of the two metal leaf springs 11 and 12 are located in the region a of the electrode opposing part 9.

The two metal leaf springs 11 and 12 are supported by support members 15, respectively, at their base parts opposite to the extended ends facing the gap g, i.e., a base part 13 of the metal leaf spring 11 and a base part 14 of the metal leaf spring 12. Each support member 15 includes a mount plate 16 present between the metal leaf spring 11 or 12 and the base member 5, leaf spring fastening screws 17 that fasten the metal leaf spring 11 or 12 to the corresponding mount plate 16, and mount plate fastening screws 18 that fasten the mount plate 16 to the base member 5. In this example, the screws 8, the leaf spring fastening screws 17, and the mount plate fastening screws 18 are male screws and are screwed into associated female-threaded holes. As shown in FIG. 1, three each of the leaf spring fastening screws 17 and the mount plate fastening screws 18 are used.

When the cell 3 is pressed and restrained by the two metal leaf springs 11 and 12 via the plate-shaped resin member 10 at a regular position for the observation by the X-ray CT system, a negative electrode terminal 19 of the cell 3 is located at substantially the same position as the extended end of the metal leaf spring 11 when viewed from the front. A positive electrode terminal 20 of the cell 3 is located at substantially the same position as the extended end of the metal leaf spring 12 when viewed from the front. A negative electrode busbar 21 extends from the negative electrode terminal 19 to be close to the base part 13 of the metal leaf spring 11 when viewed from the front. A positive electrode busbar 22 extends from the positive electrode terminal 20 to be close to the base part 14 of the metal leaf spring 12 when viewed from the front. The negative electrode busbar 21 and the positive electrode busbar 22 are arranged in this way. Thus, the region a of the electrode opposing part 9 is located between the negative electrode busbar 21 and the positive electrode busbar 22.

A flat container 23 made of an insulator contains the cell 3, the negative electrode terminal 19, the negative electrode busbar 21, the positive electrode terminal 20, and the positive electrode busbar 22. The container 23 has an outer surface in close contact with the base member 5 and an open container space. The container 23 includes a first container half 24 and a second container half 25. The first container half 24 contains the cell 3, the negative electrode terminal 19, the negative electrode busbar 21, the positive electrode terminal 20, and the positive electrode busbar 22 in its container space. The second container half 25 seals an open end of the first container half 24. A negative electrode opening 26 is formed in a side surface of an end part of the container 23 near the base part 13 of the metal leaf spring 11. The negative electrode opening 26 is a window that allows the negative electrode busbar 21 to be energized from outside. A positive electrode opening 27 is formed in a side surface of an end part of the container 23 near the base part 14 of the metal leaf spring 12. The positive electrode opening 27 is a window that allows the positive electrode busbar 22 to be energized from outside.

A window 28 penetrating the second housing half 25 in the thickness direction and corresponding to the region a of the electrode opposing part 9 is formed in the second housing half 25 to expose the surface of the plate-shaped resin member 10 on a side not in contact with the cell 3, the surface being the other surface opposite to one surface of the plate-shaped resin member 10 in contact with the cell 3. Thus, a biasing force of the two metal leaf springs 11 and 12 pressing the other surface of the plate-shaped resin member 10, that is, the surface in noncontact with the cell 3, effectively acts on the cell 3 via the plate-shaped resin member 10.

Specifically, the extended ends of the two metal leaf springs 11 and 12 facing each other pressurize the cell 3 via the plate-shaped resin member 10.

Thus, the region a of the electrode opposing part 9 of the cell 3 is pressurized directly in a region of the plate-shaped resin member 10 spreading in a plane direction. This allows the two metal leaf springs 11 and 12 to effectively pressurize the whole region a of the electrode opposing part 9, while keeping the moment length from each base part 13 or 14 to the extended end, which is the end at which the biasing force acts, relatively short. This can reduce strength required for the two metal leaf springs 11 and 12 and the support members 15 including the leaf spring fastening screws 17, the mount plates 16, and the mount plate fastening screws 18.

As the two metal leaf springs 11 and 12, different pairs of metal leaf springs having the same planar shape projected on the main surface of the base member 5 and different spring constants are prepared. The different pairs of metal leaf springs 11 and 12 are typically made of the same metal and have different thicknesses. The different pairs of metal leaf springs 11 and 12 have the same planar shape projected on the main surface of the base member 5, and thus, are easily detachably attached to the mount plates 16 with the leaf spring fastening screws 17.

This allows the X-ray CT observation of the properties of the cell 3 under a different pressing force applied to the cell 3 via the plate-shaped resin member 10 by replacing the two metal leaf springs 11 and 12 with a different pair of metal leaf springs having a different spring constant. The two metal leaf springs 11 and 12 can be replaced by detachably attaching the metal leaf springs 11 and 12 to the mount plates 16 with the leaf spring fastening screws 17 as described above, or by detachably attaching blocks each having the metal leaf spring 11 or 12 fixed to the mount plate 16 with the leaf spring fastening screws 17 to the base member 5 with the mount plate fastening screws 18.

The different pairs of metal leaf springs 11 and 12 having different spring constants include, for example, the following two types. The pair of metal leaf springs of the first type has a biasing force ranging from 0.1 MPa to 1.0 MPa, and the pair of metal leaf springs of the second type has a biasing force ranging from 2.0 MPa to 4.0 MPa.

While the cell assembly 1 for structural observation attached to the rotation support member 2 rotates about the virtual rotation axis Va, the X-ray CT system (not shown) irradiates the cell 3 with the X-rays as indicated by an open arrow in FIG. 2, obtaining a CT image as the observation result of the cell 3. The current passing through the negative electrode busbar 21 and the positive electrode busbar 22 is controlled via the negative electrode opening 26 and the positive electrode opening 27 at appropriate timing, so that the observation is carried out by changing the SOC of the cell 3.

The cell assembly 1 for structural observation of the present disclosure have the following advantages.

(1) The cell assembly 1 for structural observation includes the restraining member 4 that restrains the cell 3, which is the observation target, from both surfaces of the cell 3 in the thickness direction. The restraining member 4 includes: the plate-shaped resin member 10 that is arranged to cover the region a of the electrode opposing part 9 related to the observation of the cell 3 on one of the surfaces of the cell 3; and the two metal leaf springs 11 and 12 that extend to face each other in a direction parallel to the main surface of the plate-shaped resin member 10 toward the center part of the plate-shaped resin member 10 with the predetermined gap g left between the extended ends of the metal leaf springs, and press and bias the surface of the plate-shaped resin member 10 on a side not in contact with the cell 3. The gap g is located at a position of irradiation with the X-rays by the X-ray CT system. This allows the X-ray CT system to irradiate the cell assembly 1 for structural observation rotating about the virtual rotation axis Va with the X-rays through the gap g between the extended ends of the two metal leaf springs 11 and 12. Thus, the incoming X-rays are not blocked although the angle of the X-rays incident on the cell 3 approaches 90 degrees, improving the efficiency of the X-ray irradiation of the cell 3.

(2) In the cell assembly 1 for structural observation, the restraining member 4 is supported by the rotation support member 2 that rotates the cell 3 about the virtual rotation axis Va which is a predetermined rotation axis during the observation by the X-ray CT system, and the gap g extending in a direction of the virtual rotation axis Va between the two metal leaf springs 11 and 12 is located in the region a of the electrode opposing part 9. This can keep the two metal leaf springs 11 and 12 from absorbing the X-rays when the X-ray CT system irradiates the target cell 3 rotating about the virtual rotation axis Va with the X-rays.

(3) In the cell assembly 1 for structural observation, the two metal leaf springs 11 and 12 are respectively supported by members 15 at the base parts 13 and 14, respectively, that are opposite to their extended ends, and the extended ends are located in the region a of the electrode opposing part 9. This can keep the support members 15 respectively supporting the metal leaf springs 11 and 12 at the base parts 13 and 14, respectively, from absorbing the X-rays when the X-ray CT system irradiates the target cell 3 rotating about the virtual rotation axis Va with the X-rays.

(4) In the cell assembly 1 for structural observation, the region a of the electrode opposing part 9 is located between the positive electrode terminal 20 extending from the cell 3 and the negative electrode terminal 19 extending from the cell 3. This can keep the positive electrode terminal 20 and the negative electrode terminal 19 both extending from the cell 3 from absorbing the X-rays when the X-ray CT system irradiates the target cell 3 rotating about the virtual rotation axis Va with the X-rays.

(5) In the cell assembly 1 for structural observation, the region a of the electrode opposing part 9 is located between the positive electrode busbar 22 connected to the positive electrode terminal 20 extending from the 3 cell and the negative electrode busbar 21 connected to the negative electrode terminal 19 extending from the cell 3. This can keep the positive electrode busbar 22 and the negative electrode busbar 21 both extending from the cell 3 from absorbing the X-rays when the X-ray CT system irradiates the target cell 3 rotating about the virtual rotation axis Va with the X-rays.

(6) In the cell assembly 1 for structural observation, the container 23 is provided to contain the positive electrode terminal 20, the negative electrode terminal 19, the positive electrode busbar 22, and the negative electrode busbar 21, and the container 23 has the positive electrode opening 27 and the negative electrode opening 26 formed to allow the positive electrode busbar 22 and the negative electrode busbar 21 to be energized from outside during the observation by the X-ray CT system. This allows the positive electrode busbar 22 and the negative electrode busbar 21 both extending from the cell 3 to be energized from outside during the observation by the X-ray CT system, allowing the observation of the cell 3 under the same conditions as the charging. Specifically, the observation can be conducted by changing the SOC of the cell 3.

The cell assembly 1 for structural observation of the present disclosure can be modified in various ways other than the embodiment described with reference to FIGS. 1 and 2. For example, as the different pairs of metal leaf springs 11 and 12 having different spring constants, different pairs of metal leaf springs having the same planar shape projected on the main surface of the base member 5 and different thicknesses and being made of the same metal are prepared in the above embodiment. However, in place of them, pairs of metal leaf springs having different planar shapes (widths) projected on the main surface of the base member 5 and the same thickness and being made of the same metal may be prepared. In either case, the metal leaf springs are preferably configured to be fastened with the leaf spring fastening screws 17 of the same dimension at the same positions.

### EXPLANATION OF REFERENCE NUMERALS

a . . . Region
g . . . Gap
Va . . . Virtual rotation axis
1 . . . Cell assembly for structural observation
2 . . . Rotation support member
3 . . . Cell
4 . . . Restraining member
5 . . . Base member
6 . . . Base portion
7 . . . Mount
8 . . . Screw
9 . . . Electrode opposing part
10 . . . Plate-shaped resin member
11, 12 . . . Metal leaf spring
13, 14 . . . Base part
15 . . . Support member
16 . . . Mount plate
17 . . . Leaf spring fastening screw
18 . . . Mount plate fastening screw
19 . . . Negative electrode terminal
20 . . . Positive electrode terminal
21 . . . Negative electrode busbar
22 . . . Positive electrode busbar
23 . . . Container
24 . . . First container half
25 . . . Second container half
26 . . . Negative electrode opening
27 . . . Positive electrode opening
28 . . . Window

What is claimed is:

1. A cell assembly for structural observation for observing an internal structure of a cell with an X-ray CT system, the cell assembly comprising:
a restraining member that restrains the cell, which is an observation target, from both surfaces of the cell in a thickness direction, wherein
the restraining member includes:
a plate-shaped resin member that is arranged to cover a region of an electrode opposing part related to the observation of the cell on one of the surfaces; and
two metal leaf springs that extend to face each other in a direction parallel to a main surface of the plate-shaped resin member toward a center part of the plate-shaped resin member with a predetermined gap left between extended ends of the metal leaf springs, and press and bias a surface of the plate-shaped resin member on a side not in contact with the cell, and
the gap is located at a position of irradiation with X-rays by the X-ray CT system.

2. The cell assembly for structural observation according to claim 1, wherein the restraining member is supported by a rotation support member that rotates the cell about a predetermined rotation axis during the observation by the X-ray CT system, and the gap extending in a direction of the rotation axis between the two metal leaf springs is located in the region of the electrode opposing part.

3. The cell assembly for structural observation according to claim 1, wherein each of the two metal leaf springs has a base part that is opposite to the extended end and supported by a support member, and the extended ends are located in the region of the electrode opposing part.

4. The cell assembly for structural observation according to claim 1, wherein the region of the electrode opposing part is located between a positive electrode terminal extending from the cell and a negative electrode terminal extending from the cell.

5. The cell assembly for structural observation according to claim 1, wherein the region of the electrode opposing part is located between a positive electrode busbar connected to a positive electrode terminal extending from the cell and a negative electrode busbar connected to a negative electrode terminal extending from the cell.

6. The cell assembly for structural observation according to claim 5, wherein a container is provided to contain the positive electrode terminal, the negative electrode terminal, the positive electrode busbar, and the negative electrode busbar, and the container has a positive electrode opening and a negative electrode opening formed to allow the positive electrode busbar and the negative electrode busbar to be energized from outside during the observation by the X-ray CT system.
